(19) United States
(12) Patent Application Publication
(10) Pub. No.: US 2026/0366517 A1
(43) Pub. Date: Nov. 19, 2026

(54) COMPRESSION SYSTEM AND METHODS FOR CONTROLLING THE COMPRESSION SYSTEM

(71) Applicant: NUOVO PIGNONE TECNOLOGIE - S.R.L., Florence (IT)

(72) Inventors: Marco PELELLA, Florence, Firenze (IT); Laurence CASALI, Florence, Firenze (IT); Lorenzo GALLINELLI, Florence, Firenze (IT); Mirco CALOSI, Florence, Firenze (IT)

(21) Appl. No.: 19/135,604

(22) PCT Filed: Dec. 6, 2023
(86) PCT No.: PCT/EP2023/025511

§ 371 Date: Jun. 4, 2025

(30) Foreign Application Priority Data
Dec. 12, 2022 (IT) 102022000025341

(51) Int. Cl. F04D 27/02; F04D 17/10

(52) U.S. Cl. CPC F04D 27/0223; F04D 27/0215; F04D 17/10

(57) ABSTRACT

A compression system has a compressor with an inlet duct and an outlet duct and an anti-surge recirculation loop which may recirculate fluid from the outlet duct to the inlet duct and regulate the flow along the anti-surge recirculation loop through a throttling valve. The compression system is further provided with another throttling valve directly located at the compressor outlet flange, preferably at a distance from the compressor outlet flange which is less than three times the inner diameter of the outlet duct, and a control unit which controls and regulates the opening and closing of the throttling valves. The combined control of the opening/closing of the two throttling valves allows for finding a stable operating point of the compressor which is on the left of the expecting surge limit line of the machine.

### TECHNICAL FIELD

The subject-matter disclosed herein relates to a compression system and to methods for controlling the compression system, in particular during startup and emergency shut down (ESD).

### BACKGROUND ART

In general, a compression system comprises at least a compressor, for example a centrifugal compressor, which receives a fluid to be compressed through an inlet duct and delivers a compressed fluid through an outlet duct. Typically, the outlet duct is provided with an outlet valve which is configured to fluidly couple/decouple the compression system with a plant system (for example a pipeline system). The compressor is also mechanically coupled to a gas turbine or steam turbine or electric motor, which drives the compressor.

Typically, a modern compression system further comprises an anti-surge recirculation loop, which fluidly couples the outlet duct and the inlet duct, in order to avoid compressor surge, which is an unstable operation state of the compressor. In general, the anti-surge recirculation loop has a branch connection upstream the outlet valve and a branch connection upstream the compressor inlet duct.

A collection of expected surge points at different compressor speeds is fitted in a compressor map (i.e. a chart of compressor performance curves) as surge limit line (SLL). Surge occurs in area of the compressor map that correspond to the left side of the surge limit line (SLL). During normal operation conditions, the compressor operates in the right side of the surge limit line (SLL). However, during startup/emergency shut down, the operating point may move towards the surge line, i.e. to the left side of the surge limit line (SLL), because plant system resistant characteristic crosses the surge limit line (SLL) during compressor ramp up (startup) or compressor head is reduced with respect to the process required head due to speed reduction (emergency shut down).

Therefore, the anti-surge recirculation loop comprises an anti-surge valve which may be opened (fully or partially), at least during compressor startups, to establish a recirculation flow in the recirculation loop and returning (fully or partially) the gas discharged from the compressor to the inlet of the compressor, in order to reduce the pressure ratio of the compressor (and therefore moving to the right the operating point of the compressor in the compressor map). However, the compressor still has a stable operation state only in right side of the surge limit line (SLL) and thus the area on the left side of the surge limit line (SLL) can not be exploited.

Moreover, in order to protect the compressor from surge risk during emergency shutdowns (ESD), the compression system is typically provided with one or more additional recycle loops with additional recycle valves. In fact, during ESD, the compressor has to be turned off as quickly as possible: the power supply to the compressor driver is cut off and the anti-surge valve is set in a fully-opened configuration. However, as the compressor decelerates rapidly, it may end up in surge conditions. Therefore, additional recycle loops and valves are arranged in parallel with the anti-surge recirculation loop, allowing to equalize the pressures upstream and downstream of the compressor more quickly and therefore to avoid the surge risk.

Another important aspect to be highlighted is that the compressor driver is designed and sized in order to deliver the required torque to the compressor, which is proportional to the suction flow, suction density and head of the compressor. For this reason, it would be desirable to reduce loads on the compressor during startup, in order to reduce the size of the compressor driver and avoid oversizing, especially during pressurized startup. This is particularly important in case the compressor driver is an asynchronous motor, which has limited torque during startup (actually due to the voltage drop the motor available torque at the startup ranges between 60-70% of the rated one).

Therefore, it would be desirable to have a compression system which has lower (possibly zero) risk of unstable operation state of the compressor due to surge, in particular during startup and emergency shut down. Moreover, it would be desirable to have a compression system which has no motor oversize or additional recycle loops and/or valves.

### SUMMARY

According to an aspect, the subject-matter disclosed herein relates to a compression system having a system inlet comprising an inlet valve and a system outlet comprising an outlet valve, the compression system comprising:
a compressor having a compressor inlet flange and a compressor outlet flange;
an inlet duct having a first end fluidly coupled with the system inlet and a second end fluidly coupled to the compressor inlet flange;
an outlet duct having a first end fluidly coupled with the compressor outlet flange and a second end fluidly coupled to the system outlet;
an anti-surge recirculation loop comprising an anti-surge valve configured to control flow in the anti-surge recirculation loop, wherein a first end of the anti-surge recirculation loop is fluidly coupled to the outlet duct through a first branch connection and a second end of the anti-surge recirculation loop is fluidly coupled to the inlet duct;
a discharge throttling valve downstream of the compressor outlet flange and upstream of the first branch connection; and
a control unit configured to control opening and closing of the anti-surge valve and the discharge throttling valve.

According to another aspect, the subject-matter disclosed herein relates to a method for controlling a compression system during startup, the compression system having a system inlet and a system outlet and comprising a compressor, an anti-surge recirculating loop comprising an anti-surge valve fluidly coupling the compressor system outlet and the compressor system inlet, a discharge throttling valve located downstream of the compressor, in particular between the compressor and the anti-surge recirculating loop, an inlet valve and an outlet valve located respectively at the system inlet and at the system outlet, the method comprising the steps of:
A) setting the anti-surge valve initially in a certain configuration between a fully-closed configuration and a fully-opened configuration;
B) setting the discharge throttling valve initially in a certain configuration between a fully-closed configuration and a fully-opened configuration, so that compressor surge limit is corresponding substantially to zero flow; and
C) starting-up the compressor.

According to still another aspect, the subject-matter disclosed herein relates to a method for controlling a compression system during emergency shut down, the compression system having a system inlet and a system outlet and comprising a compressor, an anti-surge recirculating loop comprising an anti-surge valve fluidly coupling the compressor system outlet and the compressor system inlet, a discharge throttling valve located downstream of the compressor, in particular between the compressor and the anti-surge recirculating loop, an inlet valve and an outlet valve located respectively at the system inlet and at the system outlet, the method comprising the steps of:
L) setting the anti-surge valve in fully-opened configuration;
M) setting the inlet valve and the outlet valve in fully-closed configuration;
N) regulating the discharge throttling valve in a certain configuration between a fully-closed configuration and a fully-opened configuration, so that compressor surge limit is corresponding substantially to zero flow; and
O) turning off the compressor.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 shows a simplified diagram of a first embodiment of an innovative compression system as disclosed herein,

FIG. 2 shows an example of a simplified plot of a compressor map at a certain rotational speed having three operating conditions according to the system of FIG. 1,

FIG. 3 shows a flow-chart of an embodiment of a method of controlling a compression system during startup as disclosed herein, and

FIG. 4 shows a flow-chart of an embodiment of a method of controlling a compression system during emergency shut down as disclosed herein.

### DETAILED DESCRIPTION OF EMBODIMENTS

According to an aspect, the subject-matter disclosed herein relates to a compression system which has less risk, possibly zero risk, of surge. The system has a compressor with an inlet duct and an outlet duct and an anti-surge recirculation loop which may recirculate fluid from the outlet duct to the inlet duct and regulate the flow along the recirculation loop through a throttling valve. The innovative system disclosed herein is provided with another throttling valve directly located at the outlet flange of the compressor, preferably at a distance from the compressor outlet flange which is less than three times the inner diameter of the outlet duct, and a control unit which controls and regulates the opening and closing of the throttling valves. The combined control of the opening/closing of the two throttling valves allows to find a stable operating point of the compressor which is on the left of the expecting surge limit line of the machine, extending thus the stable operation conditions of the compressor and protecting the compressor from the risk of surge.

According to another aspect, the subject-matter disclosed herein relates to a method for controlling a compression system during startup, in which the compression system is initially fluidly isolated and the compressor is turned on, while the anti-surge throttle valve is fully-opened (i.e. all the fluid at the compressor outlet flange is recirculated at the compressor inlet flange) and the throttling valve at the compressor outlet flange is initially set in in a certain configuration between a fully-closed configuration and a fully-opened configuration so that the surge limit line correspond substantially to zero flow (i.e. the compressor can operate without the risk of surge).

According to still another aspect, the subject-matter disclosed herein relates to a method for controlling a compression system during emergency shut down, in which the compression system is initially fluidly isolated and the compressor is turned off, while the anti-surge throttle valve is fully-opened (i.e. all the fluid at the compressor outlet flange is recirculated at the compressor inlet flange) and the throttling valve at the compressor outlet flange is initially set in in a certain configuration between a fully-closed configuration and a fully-opened configuration so that the surge limit line correspond substantially to zero flow (i.e. the compressor can operate without the risk of surge).

Reference now will be made in detail to embodiments of the disclosure, examples of which are illustrated in the drawings. The examples and drawing figures are provided by way of explanation of the disclosure and should not be construed as a limitation of the disclosure. In fact, it will be apparent to those skilled in the art that various modifications and variations can be made in the present disclosure without departing from the scope or spirit of the disclosure. In the following description, similar reference numerals are used for the illustration of figures of the embodiments to indicate elements performing the same or similar functions. Moreover, for clarity of illustration, some references may be not repeated in all the figures.

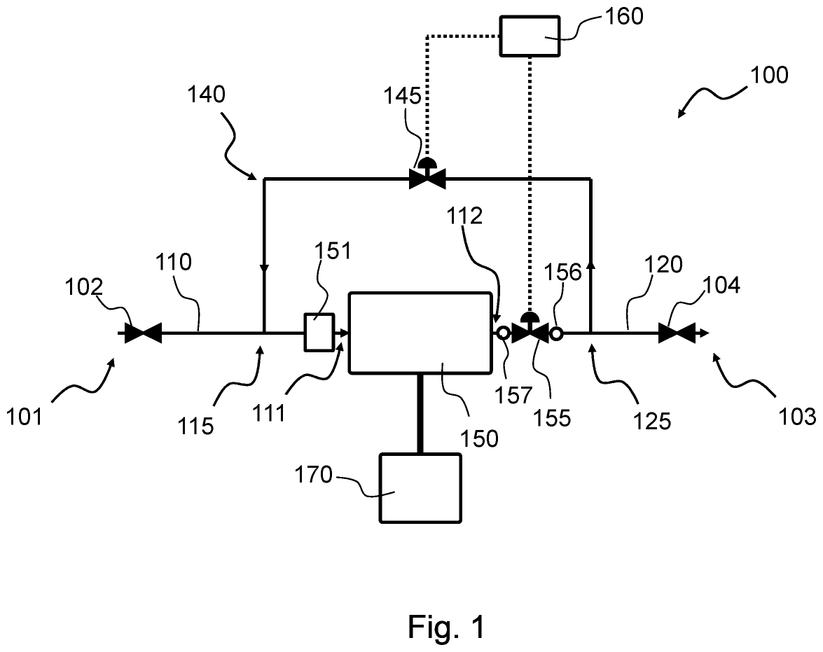

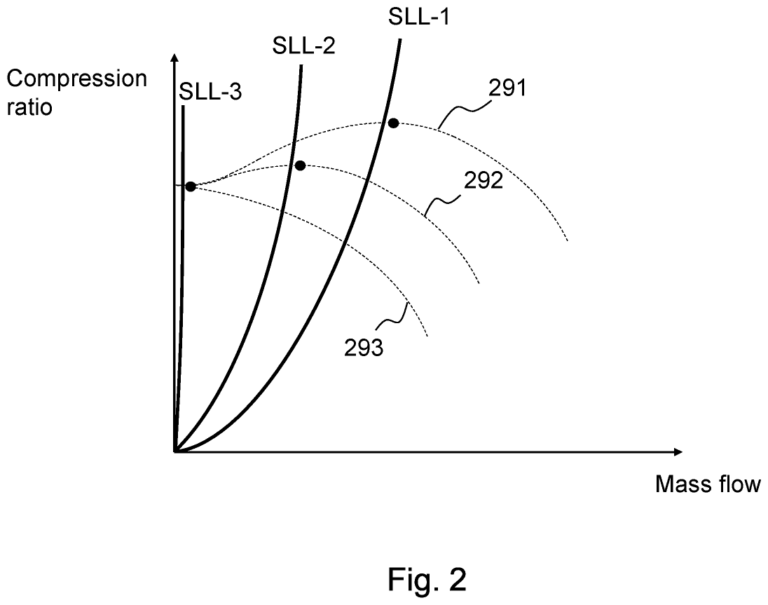

FIG. 1 shows a simplified diagram of a first embodiment of an innovative compression system 100, referred in the following as “compression system 100” or simply “system 100”. As it will better explained in the following, FIG. 2 shows an example of a simplified plot of a compressor map at a certain rotational speed having three operating conditions according to the system 100.

With non-limiting reference to FIG. 1, the system 100 includes a compressor 150, advantageously a centrifugal compressor, having a compressor inlet flange 111 and a compressor outlet flange 112. In particular, the compressor 150 is mechanically coupled to a compressor driver 170, for example an electric motor, configured to provide to the compressor 150 the required power. During operation of the compressor 150, the compressor inlet flange 111 is configured to receive a fluid and the compressor outlet flange 112 is configured to supply the fluid at higher pressure with respect to the fluid pressure at the compressor inlet flange 111. It is to be noted that the fluid received by the compressor 150 is advantageously mainly in gas phase, preferably all the fluid received by the compressor 150 is in gas phase.

It is well known that operating range of compressors, both axial and centrifugal compressors, is limited due to the flow instabilities occurring specially at low mass flow rate conditions; the most dangerous flow phenomenon is the surge. The most commonly used mathematical model that describes surge is the Greitzer model developed in 1976. Originally, this model was developed for axial compressors but it can also be used successfully in centrifugal compressors. Control algorithms for anti-surge systems may originate from the Greitzer model, that defines a parameter B, named as the Greitzer stability parameter, which determines whether a given compressor is more likely to enter surge.

According to the innovative system, as it will be better explained in the following, not only the surge condition of a compressor—which is an instable unstable operating condition—may be prevented (i.e. the compressor only operates at the right of the surge limit line, which delimits the stable operating condition of a compressor at low mass flow rates), but also the compressor may expand its stable operating condition even in an area of the compressor map which is at the left of the expected surge limit line of the compressor. This is the limit line, which would be expected without any pressure drop at the outlet of the compressor, e.g. without any throttle valve at the discharge of the compressor (see for example the black thicker line SSL-1 in FIG. 2). In particular, by acting on the throttle valve at the discharge of the compressor, is possible to “move” the surge limit line of the compressor (see for example the black thicker lines SSL-2 and SSL-3 in FIG. 2), in particular by make sure that the surge limit line corresponds substantially to zero mass flow (see in particular the black thicker line SSL-3 in FIG. 2) i.e. the compressor has a stable operating condition even at very low mass flow rates).

According to FIG. 1, the compression system 100 has a system inlet 101 provided with an inlet valve 102 which is configured to selectively fluidly couple the compression system 100 to an external fluid source in order to receive a fluid to be compressed from the external fluid source. The compression system 100 has also a system outlet 103 provided with an outlet valve 104 which is configured to selectively fluidly couple the compression system 100 to an external system, for example a process plant or an equipment which requires a pressurized fluid, in order to provide a compressed (or pressurized) fluid to the external system.

With non-limiting reference to FIG. 1, the compression system 100 further comprises an inlet duct 110 having a first end fluidly coupled to the system inlet 101, in particular to the inlet valve 102, and a second end fluidly coupled to the compressor inlet flange 111. Advantageously, the inlet duct 110 is configured to provide the fluid to be compressed to the compressor 150. As it will be apparent from the following, the fluid to be compressed provided by the inlet duct 110 may come entirely from the system inlet 101 or can come only partially from the system inlet 101; in other words, the total mass flow provided by the inlet duct 110 to the compressor 150 may be constituted by a percentage of fluid coming from the system inlet 101 of less than 100%, in particular due to a fluid recirculation inside the compressor system 100.

With non-limiting reference to FIG. 1, the compression system 100 further comprises an outlet duct 120 having a first end fluidly coupled to the compressor outlet flange 112 and a second end fluidly coupled to the system outlet 103, in particular to the outlet valve 104. Advantageously, the outlet duct 120 is configured to provide the compressed fluid to the system outlet 103. As it will be apparent from the following, the compressed fluid provided by the outlet duct 120 may be supplied entirely to the system outlet 103 or can be supplied only partially to the system outlet 103; in other words, the total mass flow supplied by the outlet duct 120 to the system outlet 103 may be constituted by a percentage of compressed fluid coming from the compressor 150 of less than 100%, in particular due to a fluid recirculation inside the compressor system 100.

According to FIG. 1, the compression system 100 comprises an anti-surge recirculation loop 140 having a first end fluidly coupled to the outlet duct 120 and a second end fluidly coupled to the inlet duct 110. For example, the anti-surge recirculation loop 140 may have a first branch connection 125 at the outlet duct 120 and a second branch connection 115 at the inlet duct 110. In particular, the first branch connection 125 may fluidly couple the first end of the anti-surge recirculation loop 140 and the outlet duct 120 and the second branch connection 115 may fluidly couple the second end of the anti-surge recirculation loop 140 and the inlet duct 110.

The anti-surge recirculation loop 140 is provided with an anti-surge valve 145, in particular a throttling valve, configured to control flow in the anti-surge recirculation loop 140, in particular the mass flow rate of compressed fluid to be recirculated from the outlet duct 120 to the inlet duct 110 in order to reduce the risk of surge of the compressor 150.

Advantageously, the system 100 may further comprise a suction flow control device 151, for example a throttling inlet valve and/or inlet guide vanes. According to a possibility, the suction flow control device 151 may be located immediately upstream the compressor 150, in particular being regulated so to reduce the power absorbed by the compressor (i.e. provided by the compressor driver 170) during startup. According to another possibility, the suction flow control device 151 may be located upstream the second branch connection 115, in particular between the inlet valve 102 and the second branch connection.

According to FIG. 1, the compression system 100 comprises a discharge throttling valve 155 located downstream of the compressor outlet flange 112 and upstream of the first branch connection 125; in other words, the discharge throttling valve 155 is arranged between the compressor outlet flange 112 and the first branch connection 125. Advantageously, the discharge throttling valve 155 is located immediately downstream of the compressor outlet flange 112; in other words, there are not further elements between the compressor outlet flange 112 and the discharge throttling valve 155.

As it will be easily understood from the skilled person, the outlet duct 120 has an inner diameter and an outer diameter and the difference between the inner and the outer diameter is the duct wall thickness. Preferably, the discharge throttling valve 155 is located at a distance from the compressor outlet flange 112 which is less than three times the inner diameter of the outlet duct 120. In particular, the location of the discharge throttling valve 155, in agreement with Greitzer theory, will change the characteristic curve of the compressor 150 provided with the discharge throttling valve 155 (see for example characteristic curves 292 and 293 in FIG. 2) with respect to the characteristic curve of the compressor 150 without any discharge throttling valve (see for example characteristic curve 291 in FIG. 2); it has been studied and tested that there is a value of the distance (which may vary for each type and/or model of compressor) for which is possible to obtain a characteristic curve without instability zone at low flow mass rate, i.e. that surge limit line corresponds to zero flow.

According to a possibility, in particular if the discharge throttling valve 155 is located at a distance from the compressor outlet flange 112 which is more than three times the inner diameter of the outlet duct 120, the discharge throttling valve 155 and/or other valves of the compressor system 100 may be controlled by means of a control algorithm, referred in the following as “active surge controller”, that acts on those valves with the aim of avoiding the risk of surge. In particular, when compressor operative point position moves to the left of the surge limit line, the active surge controller starts to open and close valves in a periodic way and with a frequency self-adjusted to be in line with compressor surge cycles such to avoid surge phenomenon. Advantageously, the control unit 160 may implement the active surge controller. As a non-limiting example, the active surge controller could be a closed-loop control system which could be “Proportional-Integral-Derivative” (PID) type, “high-gain adaptive control” type or similar.

With non-limiting reference to FIG. 2, it is shown a simplified plot of how the combination of the discharge throttling valve 155 and the anti-surge valve 145 may reduce and possibly eliminate the risk of surge of the compressor 150. In particular, in FIG. 2 are shown three different operating conditions of the compressor 150: a first operating condition (see characteristic curve 291 and surge limit line SLL-1) in which the discharge throttling valve 155 is in fully-opened configuration, i.e. having substantially zero pressure drop at the compressor discharge; a second operating condition (see characteristic curve 292 and surge limit line SLL-2) in which the discharge throttling valve 155 is set in a certain configuration between a fully-closed configuration and a fully-opened configuration; and a third operating condition (see characteristic curve 293 and surge limit line SLL-3) in which the discharge throttling valve 155 is set in a certain configuration between a fully-closed configuration and a fully-opened configuration and the anti-surge valve 145 is set in a certain configuration between a fully-closed configuration and a fully-opened configuration. More in particular, the dashed black curves on the plot are the characteristic curves of the compressor, the thicker black lines are the surge limit lines (SLL) of the compressor and the black dots are examples of stable operating points of the compressor which can be achieved with a proper regulation of the discharge throttling valve and the anti-surge valve. It is to be noted that the three operating conditions shown in FIG. 2 refer to a first operating speed of the compressor 150. However, the same may be applied to the compressor operating at a different speed, for example a second speed which is less than the first speed.

With non-limiting reference to FIG. 1, the compressor system 100 comprises a control unit 160 configured to control and regulate opening and closing of the anti-surge valve 145 and the discharge throttling valve 155. Advantageously, as it will be better explained in the following, the control unit 160 may control and regulate opening and closing of the anti-surge valve 145 and the discharge throttling valve 155 according at least to one or more fluid pressure measures, in particular fluid pressure measures taken downstream to the compressor 150, and/or one or more comparison between two or more fluid pressure measures. Preferably, the control unit 160 may also regulate the suction flow control device 151, for example the opening and closing of a throttling inlet valve or inlet guide vanes.

Advantageously, the compression system 100 further comprises a first pressure gauge 156 configured to measure a first fluid pressure and to provide a first fluid pressure measure to the control unit 160. Advantageously, the first pressure gauge 156 is located downstream of the discharge throttling valve 155, in particular between the discharge throttling valve 155 and the first branch connection 125, and provides a measure of the fluid pressure downstream of the discharge throttling valve 155. It is to be noted that the first pressure gauge 156 may be configured to measure and provide the measure continuously when the compressor 150 is operative.

Advantageously, the compression system 100 further comprises a second pressure gauge 157 configured to measure a second fluid pressure and to provide a second fluid pressure measure to the control unit 160. Advantageously, the second pressure gauge 157 is located downstream of the compressor outlet flange 112, in particular between the compressor outlet flange 112 and the discharge throttling valve 155, and provides a measure of the fluid pressure upstream of the discharge throttling valve 155. It is to be noted that the second pressure gauge 157 may be configured to measure and provide the measure continuously when the compressor 150 is operative.

According to a possibility, the control unit 160 may be configured to provide a comparison between the first fluid pressure measure provided by the first pressure gauge 156 and the second fluid pressure measure provided by the second fluid gauge 157. For example, if the comparison between the two fluid pressures results in a difference of tenths or hundredths of a bar (e.g. according to a tolerance margin set), the control unit 160 may be configured control and regulate opening and closing of the anti-surge valve 145 and the discharge throttling valve 155, so that the difference between the two measures is never less than zero or close to zero (i.e. so that the direction of the fluid is never reversed).

According to another aspect, the subject-matter disclosed herein relates to a method for controlling a compression system during startup, for example a compression system as described above, having a system inlet 101 and a system outlet 103 and comprising a compressor 150, an anti-surge recirculating loop 140 comprising an anti-surge valve 145 fluidly coupling the compressor system outlet 103 and the compressor system inlet 101, a discharge throttling valve 155 located downstream of the compressor 150, in particular between the compressor 150 and the anti-surge recirculating loop 140, an inlet valve 102 and an outlet valve 104 located respectively at the system inlet 101 and at the system outlet 103.

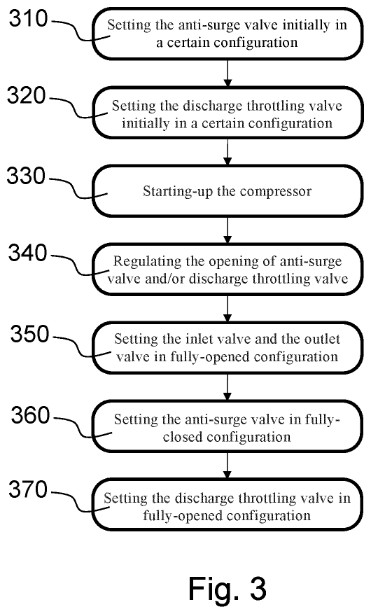

With non-limiting reference to FIG. 3, the method comprises the steps of:
A) setting 310 the anti-surge valve 145 initially in a certain configuration between a fully-closed configuration and a fully-opened configuration;
B) setting 320 the discharge throttling valve 155 initially in a certain configuration between a fully-closed configuration and a fully-opened configuration, so that compressor surge limit is corresponding substantially to zero flow; and
C) starting-up 330 the compressor 150.

It is to be noted that FIG. 3 is only schematic and two or more of the previous step 310, 320 and 330 may be performed simultaneously or substantially simultaneously. It is also to be noted that step C means that a compressor driver 170 is providing power to the compressor 150 in order to run the compressor from a zero rotating speed to a minimum operating speed, which may depend on the compressor type and/or model.

According to some embodiments, the method may also comprise a step of setting the inlet valve 102 and the outlet valve 104 in fully-closed configuration, in order to isolate the compression system 100; in particular, this step may be performed before step C. According to other embodiments, the method may also comprise a step of setting the inlet valve 102 and/or the outlet valve 104 in a certain configuration between a fully-closed configuration and a fully-opened configuration; in particular, this step may be performed before step C. Advantageously, when the compressor 150 has reached a minimum operating speed, the method further comprises the step of:
D) regulating 340 the opening of the anti-surge valve 145 between a fully-closed configuration and a fully-opened configuration in order to generate a backpressure upstream of the anti-surge valve 145 substantially equal to the pressure downstream the outlet valve 104 and possibly to generate a pressure downstream of the anti-surge valve 145 substantially equal to the pressure upstream the inlet valve 102.

Advantageously, during step D also the opening of the discharge throttling valve 155 is regulated between a fully-closed configuration and a fully-opened configuration. When the backpressure upstream of the anti-surge valve 145 has substantially reached the pressure downstream the outlet valve 104, the inlet valve 102 and the outlet valve 104 are set in fully-opened configuration—step E—(see also step 350 in FIG. 3). In particular, the outlet valve 104 is set in fully-opened configuration when the pressure downstream of the anti-surge valve 145 has substantially reached the pressure upstream the inlet valve 102. Finally, the anti-surge valve 145 is set in fully-closed configuration—step F—(see also step 360 in FIG. 3) and the discharge throttling valve 155 is set in fully-opened configuration—step G—(see also step 370 in FIG. 3). It is to be noted that two or more of the previous step 350, 360 and 370 may be performed simultaneously or substantially simultaneously. It is also to be noted that the steps of regulating and setting throttle valves (e.g. step 310, 320, 340, 350 and 370) may be performed by a control unit 160. In particular, the regulation is performed by the control unit 160 essentially through a program or programs, that may be “software” or “firmware”, stored in a program memory of the control unit 160. As a non-limiting example, the control unit 160 could be a computer, Programmable Logic Controller (PLC), Distributed Control System (DCS), microprocessor or similar device. It is also to be noted that the discharge throttling valve 155 is configured and designed so to limit pressure drops when is set in fully-opened configuration. In particular, when the discharge throttling valve 155 is set in fully-opened configuration, the pressure drop of the compression system 100 due to the presence of the discharge throttling valve 155 is less than 1% of the discharge total pressure, i.e. the pressure at the outlet flange 112.

According to another aspect, the subject-matter disclosed herein relates to a method for controlling a compression system during emergency shut down, for example a compression system as described above, having a system inlet 101 and a system outlet 103 and comprising a compressor 150, an anti-surge recirculating loop 140 comprising an anti-surge valve 145 fluidly coupling the compressor system outlet 103 and the compressor system inlet 101, a discharge throttling valve 155 located downstream of the compressor 150, in particular between the compressor 150 and the anti-surge recirculating loop 140, an inlet valve 102 and an outlet valve 104 located respectively at the system inlet 101 and at the system outlet 103.

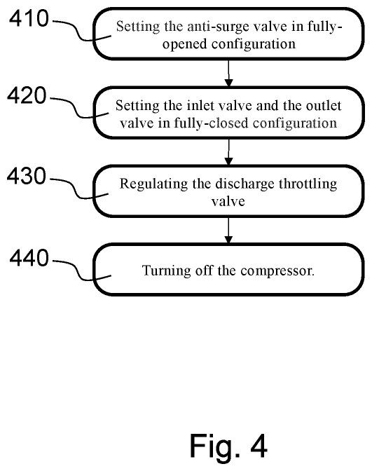

During normal shutdowns, the deceleration of the compressor is controlled and the valves are gradually opened. During emergency shutdowns, indeed, the power from the compressor driver to the compressor is immediately cut and the opening of the valves is fast. With non-limiting reference to FIG. 4, the method described herein comprises the steps of:
H) setting 410 the anti-surge valve 145 in fully-opened configuration;
I) setting 420 the inlet valve 102 and the outlet valve 104 in fully-closed configuration;
L) regulating 430 the discharge throttling valve 155 in a certain configuration between a fully-closed configuration and a fully-opened configuration, so that compressor surge limit is corresponding substantially to zero flow; and
M) turning off 440 the compressor.

It is to be noted that FIG. 4 is only schematic and two or more of the previous step 410, 420, 430 and 440 may be performed simultaneously or substantially simultaneously. It is also to be noted that step M means that the power from a compressor driver 170 to the compressor 150 is immediately cut, in order to brake the compressor from an operating speed to a zero rotating speed.

1. A compression system having a system inlet comprising an inlet valve and a system outlet comprising an outlet valve, the compression system comprising:
a compressor having a compressor inlet flange and a compressor outlet flange;
an inlet duct having a first end fluidly coupled with the system inlet and a second end fluidly coupled to the compressor inlet flange;
an outlet duct having a first end fluidly coupled with the compressor outlet flange and a second end fluidly coupled to the system outlet;
an anti-surge recirculation loop comprising an anti-surge valve configured to control flow in the anti-surge recirculation loop, wherein a first end of the anti-surge recirculation loop is fluidly coupled to the outlet duct and a second end of the anti-surge recirculation loop is fluidly coupled to the inlet duct;
a discharge throttling valve located downstream of the compressor outlet flange; and
a control unit configured to control and regulate opening and closing of the anti-surge valve and the discharge throttling valve;
wherein the first end of the anti-surge recirculation loop is fluidly coupled to the outlet duct through a first branch connection, wherein the discharge throttling valve is located upstream of the first branch connection.

2. The compression system of claim 1, wherein the compressor is a centrifugal compressor.

3. The compression system of claim 1, wherein the outlet duct has an inner diameter, wherein the discharge throttling valve is located at a distance from the compressor outlet flange which is less than three times the inner diameter of the outlet duct.

4. The compression system of claim 1, further comprising a first pressure gauge located between the discharge throttling valve and the first branch connection, the first pressure gauge being configured to measure a first fluid pressure and to provide a first fluid pressure value to the control unit.

5. The compression system of claim 4, further comprising a second pressure gauge located between the compressor outlet flange and the discharge throttling valve, the second pressure gauge being configured to measure a second fluid pressure and to provide a second fluid pressure value to the control unit, wherein the control unit is configured to provide a comparison between the first fluid pressure value and the second fluid pressure value.

6. The compression system of claim 4, wherein the control unit is configured to regulate the opening and closing of the anti-surge valve according at least to the first fluid pressure value received and/or the comparison between the first fluid pressure value and the second fluid pressure value.

7. The compression system of claim 1, further comprising a suction flow control device, wherein the suction flow control device is an inlet throttling valve and/or inlet guide vanes, wherein the suction flow control device is located upstream of the compressor inlet flange.

8. Method for controlling a compression system during startup, the compression system having a system inlet and a system outlet and comprising a compressor, an anti-surge recirculating loop comprising an anti-surge valve fluidly coupling the compressor system outlet and the compressor system inlet, a discharge throttling valve located downstream of the compressor, in particular between the compressor and the anti-surge recirculating loop, an inlet valve and an outlet valve located respectively at the system inlet and at the system outlet, the method comprising the steps of. A) setting the anti-surge valve initially in a certain configuration between a fully-closed configuration and a fully-opened configuration;
B) setting the discharge throttling valve initially in a certain configuration between a fully-closed configuration and a fully-opened configuration, so that compressor surge limit is corresponding substantially to zero flow; and
C) starting-up the compressor.

9. The method of claim 8, wherein when the compressor has reached a minimum operating speed, the method further comprises the step of:
D) regulating the opening of the anti-surge valve between a fully-closed configuration and a fully-opened configuration in order to generate a backpressure upstream of the anti-surge valve substantially equal to the pressure downstream the outlet valve.

10. The method of claim 9, wherein during step D also the opening of the discharge throttling valve is regulated between a fully-closed configuration and a fully-opened configuration until the backpressure upstream of the anti-surge valve is substantially equal to the pressure downstream the outlet valve.

11. The method of claim 9, wherein when the backpressure has substantially reached the pressure downstream the outlet valve, the method further comprises the steps of:
E) setting the inlet valve and the outlet valve in fully-opened configuration;
F) setting the anti-surge valve in fully-closed configuration; and
G) setting the discharge throttling valve in fully-opened configuration.

12. Method for controlling a compression system during emergency shut down, the compression system having a system inlet and a system outlet and comprising a compressor, an anti-surge recirculating loop comprising an antisurge valve fluidly coupling the compressor system outlet and the compressor system inlet, a discharge throttling valve located downstream of the compressor, in particular between the compressor and the anti-surge recirculating loop, an inlet valve and an outlet valve located respectively at the system inlet and at the system outlet, the method comprising the steps of:
H) setting the anti-surge valve in fully-opened configuration;
I) setting (420) the inlet valve and the outlet valve in fully closed configuration;
L) regulating the discharge throttling valve in a certain configuration between a fully-closed configuration and a fully-opened configuration, so that compressor surge limit is corresponding substantially to zero flow; and
M) turning off the compressor.
